(19) United States
(12) Patent Application Publication
(10) Pub. No.: US 2015/0271097 A1
(43) Pub. Date: Sep. 24, 2015

(54) Systems And Methods For Effective Communications

(71) Applicant: Steeve Teong Sin Kay, Newport Coast, CA (US)

(72) Inventor: Steeve Teong Sin Kay, Newport Coast, CA (US)

(21) Appl. No.: 14/339,139

(22) Filed: Jul. 23, 2014

Related U.S. Application Data
(60) Provisional application No. 61/955,490, filed on Mar. 19, 2014.

(51) Int. Cl. H04L 12/911; H04L 12/761

(52) U.S. Cl. CPC H04L 47/783; H04L 45/16

(57) ABSTRACT

The present inventive subject matter is drawn to apparatus, systems, configurations, and methods for allowing resources within one or more organizations to efficiently communicate with one another. In some aspects of the invention, a system that enables efficient communication among resources is presented. When a resource needs to send a message to one or more other resources, instead of directly sending the message to the target resources, the resource indiscriminately broadcasts the message to multiple different resources. Each of the resources has a corresponding proxy that, upon receiving the message, is configured to determine whether the message is directed to the corresponding resource. The proxy is configured to restrict presentation of the message when the proxy determines that the message is directed to the corresponding resource.

This application claims priority to U.S. Application 61/955,490, filed Mar. 19, 2014. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The present invention is generally related to communication technologies.

### BACKGROUND

The following description includes information that may be useful in understanding the present invention. It is not an admission that any of the information provided herein is prior art or relevant to the presently claimed invention, or that any publication specifically or implicitly referenced is prior art.

Communications is a foundation of any organization. The advent of technologies enables more convenient and efficient ways of communicating with each other such as e-mails, texting, and others. These tools work very well when the sender of a message knows who the intended receiver(s) is supposed to be. However, there are many instances where targeted communication might not be very effective. For example, as organization structure becomes increasingly complex, along with increasing rate of personnel changes, much time has been spent (or wasted) in identifying the correct recipient for a message or a request. In addition, inter-organizational communications also make it challenging in identifying the correct recipients of a message or a task request as the sender often times does not have access to the organizational structure of the organization to which the intended recipient belong.

Efforts have been made in making it easier for a sender to communicate without having to identify the identity of the target recipient(s). For example, U.S. Pat. No. 6,581,404 issued to Wright et al., entitled “Project Specific Communications System and Method” filed Jun. 17, 2003, discloses a system for providing communications for projects that involve multiple resource providers. In the communication system disclosed in Wright, each resource provider supplies a template (or a database) storing the resource capability and interest in the project. When the owner of a new project sends a bidding request (that includes information regarding the project) to the system, the system compares the project information with the templates of the multiple resource providers and only forward the request to the providers whose templates satisfy the requirements set forth in the request.

U.S. Pat. No. 8,099,311 issued to La Vecchia et al. entitled “System and Method for Routing Tasks to a User in a Workforce,” filed Jan. 17, 2012 teaches a routing system for efficiently routing tasks to users. Similar to Wright, the system disclosed in La Vecchia relies on a central server that stores attributes of different users and routes tasks to the users based on their attributes.

Other examples of communication tools include
U.S. Pat. No. 7,502,748 issued to Baldwin et al. entitled “Job Matching System and Method,” filed Mar. 10, 2009;
U.S. Patent Publication 2010/0174577 to Duffy et al. entitled “Automated Task Delegation Based on Skills,” filed Jul. 8, 2010; and
U.S. Patent Publication 2002/0029161 to Brodersen et al. entitled “Assignment Manager,” filed Mar. 7, 2002.

One of the problems of the systems disclosed in Wright and La Vecchia (and many other similar systems) is that they rely on a central server that performs the matching and routing of bidding requests and/or tasks. When the number of participants involved in the communication system increases, the central server becomes the bottleneck of the communication and a failure of the central server means a complete melt down of the communication system. Thus, there is still a need for providing a better communication system.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The present inventive subject matter is drawn to apparatus, systems, configurations, and methods for efficiently communicating among resources within one or more organizations. In some aspects of the invention, a system that enables efficient communication among resources is presented. When a resource needs to send a message (e.g., a task, a request, a bid, etc.) to one or more other resources, instead of directly sending the message to the target resources, the resource indiscriminately broadcasts the message to multiple different resources (e.g., all resources within a department, all resources with an organization, all resources within a contact list, etc.). Each of the resources has a corresponding proxy that, upon receiving the message, is configured to determine whether the message is directed to the corresponding resource. The proxy is configured to restrict presentation of the message when the proxy determines that the message is directed to the corresponding resource.

The communication management system includes several resources that are communicatively coupled with each other via their corresponding proxies. Each resource is associated with a resource composite code that represents a set of attributes of the resource.

In some embodiments, a first resource is configured to indiscriminately broadcast, to the other resources, a task comprising a task composite code that represents properties of the task. The proxy of a second resource is configured to, upon receiving the task and its associated task composite code from the first resource, generate a resource-task compliance profile by comparing the task composite code against the resource composite code of the second resource. The proxy of the second resource is also configured to restrict presentation of the task to the second resource when the resource-task compliance profile satisfies a set of rules.

The resources can include different types of resources within an organization. For example, the resources can include human (e.g., workers, managers, CEOs, engineers, etc.). The resources can also include a machine or a computing device.

In some embodiments, the proxy includes a software program that is executable by at least one processing unit.

In some embodiments, the proxy of a resource can provide an interface that allows the corresponding resource to modify the resource composite code. Upon receiving the task composite code, the proxy of the second resource can also be configured to dis-integrate the task composite code into its dis-integrated elements. Each of the dis-integrated elements represents a requirement of the task. The proxy of the second resource is configured to then determine the resource-task compliance profile by comparing each of the dis-integrated elements against the resource composite code.

The resource composite code can also be associated with programming code that is executable by a set of processors. In some of these embodiments, the proxy is configured to execute the programming code upon receiving the task. The programming code can be configured to analyze the task composite code and perform an action based on the analysis. The action can include responding to the first resource. The action can also include bidding for the task. The action can also include retrieving additional information related to the task and presenting the additional information to the second resource.

In another aspect of the invention, a method of managing communications among resources of an organization is presented. The organization includes several resources that are communicatively coupled with each other via their corresponding proxies. The method includes the step of assigning to each resource in the plurality of resources a resource composite score representing a set of attributes of the resource. The method includes the step of indiscriminately broadcasting, by a first resource to the plurality of resources, a task comprising a task composite code that represents properties of the task. The method also includes the step of upon receiving the task and its task composite code at a proxy of a second resource, generating a resource-task compliance profile by comparing the task composite code against the resource composite code of the second resource. The method also includes the step of restricting, by the proxy, presentation of the task to the second resource when the resource-task compliance profile satisfies a set of rules.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an example computing environment in which a system for managing communications among resources is presented.

FIG. 2 illustrates the schematic of an example proxy of some embodiments.

FIG. 3 illustrates an example of automatically determining an ad-hoc workflow for a task.

FIG. 4 conceptually illustrates interactions with a resource under the automatic workflow generation system of some embodiments.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). Hereinafter, a processor can mean at least one processing unit (e.g., a microprocessor, a processing core, etc.) for executing software instructions. The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Overview

The present inventive subject matter is drawn to apparatus, systems, configurations, and methods for allowing resources within one or more organizations to efficiently communicate with one another. In some aspects of the invention, a system that enables efficient communication among resources is presented. When a resource needs to send a message (e.g., a task, a request, a bid, etc.) to one or more other resources, instead of directly sending the message to the target resources, the resource indiscriminately broadcasts the message to multiple different resources (e.g., all resources within a department, all resources with an organization, all resources within a contact list, etc.). Each of the resources has a corresponding proxy that, upon receiving the message, is configured to determine whether the message is directed to the corresponding resource. The proxy is configured to restrict presentation of the message when the proxy determines that the message is directed to the corresponding resource.

There are many benefits to this invention. First, it eliminates the need for the sender of a message to identify recipient(s) of the message. Often times, it takes (and wastes) much time to determine the person(s) who is responsible for a certain task within the organization, and especially if the person(s) is outside of the organization. Many times the sender inadvertently omits one or more recipients in the original e-mail. This happens often when the project associated with the message is complex that involves personnel from different departments and organizations. Second, it eliminates the need for a central server to analyze messages and route messages to the proper recipients. As organization structure becomes increasingly more complex, the processing required to analyze tremendous amount of messages and resources can be cumbersome. The central server often becomes the bottleneck of this communication system, or even liability when the central server breaks down.

The system contemplated herein imitates how hormones work in a human body. Hormones are sent through the blood stream to different parts of the body and interact with cells within the body indiscriminately. Each cell in the body has a receptor that would determine whether the hormone is something that is needed by the cell. The receptor would ignore the hormone or receives the hormone based on the determination.

Message Broadcasting System

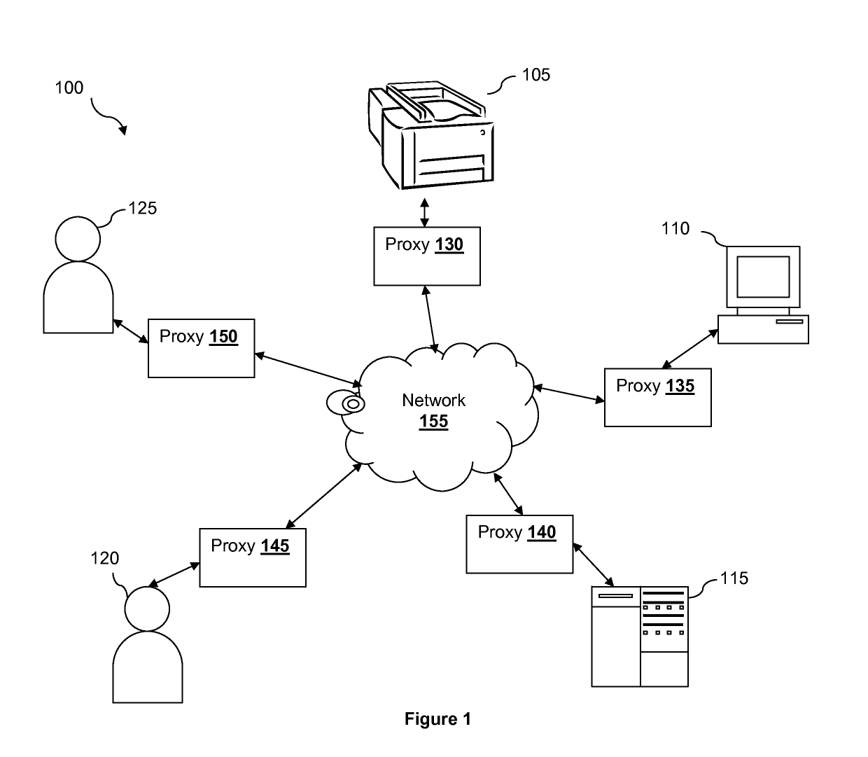

FIG. 1 illustrates an example resource communication system 100. The resource communication system 100 includes several resources: resource 105, resource 110, resource 115, resource 120, resource 125, and resource 130. Resources 105-130 can be different types of resources for an organization. For example, the resources, such as resource 120 and resource 125, can be a human worker (e.g., a CEO, an engineer, etc.). The resources can also be a machine or computing device that provides services. For example, resource 105 is a printer, resource 110 is a personal computer, and resource 115 is a web server. In addition, a resource can also mean a collection of (or a combination of) human workers, machines, and computing devices (e.g., an entity, a department, a company, etc.).

Each of the resources has a corresponding proxy that is communicatively coupled with the resource. For example, resource 105 is communicatively coupled with proxy 130, resource 110 is communicatively coupled with proxy 135, resource 115 is communicatively coupled with proxy 140, resource 120 is communicatively coupled with proxy 145, and resource 125 is communicatively coupled with proxy 150. The resource and its corresponding proxy can be communicatively coupled with each other via a connection (e.g., a WiFi connection, a USB connection, a Bluetooth connection, an Ethernet connection, etc.) or an interface (e.g., an application programming interface (API), a user interface, etc.) such that the resource and its corresponding proxy can communication information with each other.

As shown in FIG. 1, the resources 105-125 are communicatively coupled with each other over a network 155 via their corresponding proxies 130-150. The network 155 can be any type of network such as the Internet, a local area network (LAN), a wide area network (WAN), a wireless network, a virtual private network (VPN), or an ad-hoc peer-to-peer network. As such, each proxy can either establish a direct connection with a target proxy or establish a connection with the target proxy through another proxy.

When a resource (e.g., the CEO 125) wants to send a message (e.g., ordering someone or a service to perform a task), instead of having to identify the person or service that is capable of performing the task and then send the request to that person or service directly, the resource can use its proxy (e.g., proxy 150) to indiscriminately broadcast the message to the several resources In some embodiments, the proxy 150 is configured to broadcast the message to every resource within the department or every resource within the organization. In other embodiments, the proxy 150 is configured to broadcast the message only to a selected list of resources.

In this example, the proxy 150 is configured to broadcast the message to the resources 105-120 by sending the message to proxies 130-145. Upon receiving the message, each of the proxies 130-145 is configured to determine whether the message is relevant to the corresponding resource. The proxy is also configured to then present the message to the corresponding resource when the proxy determines that the message is indeed relevant to the corresponding resource. In some embodiments, the proxy is configured to present the message to the resource only when it is determined that the message is relevant to the resource.

In some embodiments, the proxy determines whether the message is relevant to the resource by analyzing attributes of the message and properties of the corresponding resource. For example, when the message is intended for resources that belong to a particular group within an organization, then the proxy would determine that the message is relevant to the corresponding resource only if the corresponding resource belongs to that particular group. In another example, if the message indicates a set of capability requirements, the proxy would determine that the message is relevant to the corresponding resource only if the corresponding resource can fulfill the set of capability requirements. The capability requirements can vary depending on the type of service that is required to be performed. The requirements, for services being performed by a machine or a computing device, can include hardware requirements (e.g., processor speed, memory capacity, networking bandwidth), load requirement (e.g., how busy/occupied is the resource), and others. For services that can be performed by human resources, the requirements can include expertise/knowledge, security level, certificate, education level, interests of the resource (e.g., whether the human is interested in performing this type of work/service), experience, past performance evaluation, or even other more subjective status such as trustworthiness level, reliability level, etc.

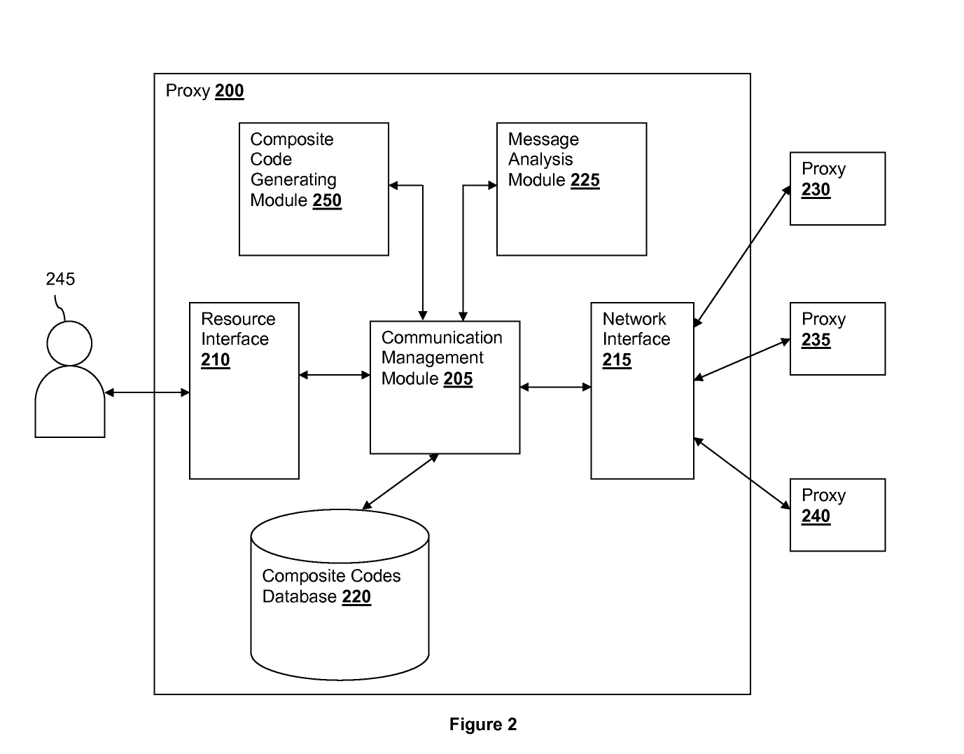

FIG. 2 illustrates an example schematic of a proxy 200 that can be used by (and correspond to) any one of the resources 105-125 from FIG. 1. Proxy 200 includes a communication management module 205, a resource interface 210, a network interface 215, a composite codes database 220, a message analysis module 225, and a composite code generating module 250. In some embodiments, the communication management module 205, the resource interface 210, the network interface 215, the message analysis module 225, and the composite code generating module 250 are implemented as software programs that are executable by at least one processing unit (e.g., a microprocessor, a processing core, etc.). As shown, composite code generating module 250, message analysis module 225, resource interface 210, network interface 215 can communicate with each other through the communication management module 205.

Composite codes database 2200 of some embodiments is implemented in a non-transitory permanent data storage such as a hard drive, a flash memory, etc. In some embodiments, the database 220 can be a file system, database management system, a document, a table, etc.

Resource interface 210 is configured to provide an interface for communication between proxy 200 and its corresponding resource (e.g., resource 245). In some embodiments, when resource 245 is a human worker, resource interface 210 is coupled with input/output devices (e.g., touch screen display, keyboard/mouse and monitor, etc.) to communicate with the human worker 245. In some of these embodiments, resource interface 210 can also provide a user interface (e.g., a graphical user interface) for interacting with the human worker 245.

In other embodiments, when resource 245 is a machine or a computing device, resource interface 210 can be a connected to a physical connection (e.g., a physical port configured to connect to the corresponding resource via a cable) to communicate with resource 245 via a physical layer (transmitting and receiving bits of data). Resource interface 210 can also provide an application programming interface (API) for interacting with the machine or computing device 245 via a software layer (communicating via API function calls).

As mentioned above, each resource has associated properties that describe the capabilities, interests and other attributes related to the resource. For a human resource, the properties can include expertise/knowledge level, security level, certificate, education level, interests (e.g., what type of work/service does the human resource is interested in), experience, past performance evaluation, and even other more subjective status such as trustworthiness level and reliability level. These properties can be derived from information supplied by the resource or other resources. For example, resource 245 can supply information to proxy 200 via resource interface 210 (e.g., by inputting expertise/knowledge level, security level, certificates held, education level, interests, etc.). Proxy 200 can also communicate with other resources to verify the information about resource 245. In addition, proxy 200 can also connect to a central server where some of the information about resource 245 can be obtained and/or verified. It is contemplated that the expertise/knowledge level, reliability level, trustworthiness level can change based on past performances. Thus, proxy 200 can be configured to periodically obtain updated information from a central server that keeps track of performances of resource 245.

For a resource that is a machine or a computing device, the properties can include its capabilities, lists of services that can be rendered, work load information, status (e.g., on, off, hibernation, etc.), priority information, etc. Proxy 200 can obtain this information from communicating with resource 245 via the resource interface 210, from other resources, and/or from a central database that stores data related to the resources.

Once information of the properties of resource 245 is obtained, composite code generating module 250 of proxy 200 can be configured to codify the properties into a resource composite code. Different embodiments of the composite code generating module 250 implement the resource composite code in different ways. For example, the resource composite code can be implemented as a text code, an XML file, a relational database, etc. Regardless of the implementation methods, the generated composite code comprises at least several independent codes, where each independent code represents a property of the resource (e.g., a property name and value pair).

In some embodiments, proxy 200 can be configured to use composite code generating module 250 to generate multiple resource composite codes (for different departments, for different organizations, for different contexts, etc.). The communication management module 205 then stores these resource composite codes in the composite code database 220.

Once a resource composite code is generated, proxy 200 of some embodiments can provide an interface via resource interface 210 that allows resource 245 to modify the resource composite code. In some embodiments, proxy 200 is configured to allow resource 245 to modify only a portion of the resource composite code (e.g., a subset of the independent codes). This way, proxy 200 allows resource 245 to have limited controls over what types of messages/tasks resource 245 would receive.

As mentioned above, each message being sent from a resource has a set of attributes related to the message. The attributes can include information that indicates which resources are the intended recipient of the message (e.g., group/department/organization data to which resources belong), subject matter of the message, etc. If the message includes a task request, the attributes can also include information about the task and capability requirements for resources that can perform the task. The capability requirements can vary depending on the type of service that is required to be performed. The requirements, for services being performed by a machine or a computing device, can include hardware requirements (e.g., processor speed, memory capacity, networking bandwidth), load requirement (e.g., how busy/occupied is the resource), and others. For services that can be performed by human resources, the requirements can include expertise/knowledge, security level, certificate, education level, interests of the resource (e.g., whether the human is interested in performing this type of work/service), experience, past performance evaluation, or even other more subjective status such as trustworthiness level, reliability level, etc.

When resource 245 requests to send a message via proxy 200, composite code generating module 250 of some embodiments is configured to generate a message composite code for the message. Similar to the resource properties, different embodiments of the composite code generating module 250 codifies the attributes of a message in different ways (e.g., text code, XML file, database, etc.). Regardless of the implementation methods, the generated composite code comprises at least several independent codes, where each independent code represents an attribute of the message (e.g., an attribute name and value pair).

It is contemplated that composite code generating module 250 generates the resource composites codes and message composite codes according to a standard (a set of rules). The standard can include a list of predefined attributes for messages and possible values for the attributes, and a list of properties for resources and possible values for the properties. The standard can also include rules (e.g., formatting rules, codes size rules, etc.) for generating the composite codes. In some embodiments, the standard is distributed among the resources (e.g., resources 105-125) such that the resources can interpret composite codes generated by other resources. In some embodiments, proxy 200 can store the standard in composite codes database 220.

In some embodiments, the standard can be distributed to resources from different organizations, such that resources from different organizations can communicate with each other using the system disclosed herein. It is contemplated that the more resources using the system, the more benefits they can get.

In order to generate the message composite code, the composite code generating module 250 must first obtain attributes of the message. In some embodiments, the composite code generating module 250 can obtain attributes of the message from the content of the message. For example, the composite code generating module 250 can parse through the content and identify keywords (e.g., department names, task urgency, task requirements, etc.) that can be used as attributes. The composite code generating module 250 can also prompts resource 245 (e.g., via resource interface 210) for attributes information that cannot be obtained from the content of the message.

As shown, proxy 200 is communicatively coupled with other resources via their corresponding proxies (e.g., proxy 230, proxy 235, and proxy 240). Once the message composite code is generate, the communication management module 205 is configured to attach the message composite code to the message and then indiscriminately broadcast the message to different resources via the network interface 215 (and via their corresponding proxies, such as proxy 230, proxy 235, and proxy 240) without considering the properties of these resources.

When proxy 200 receives a message from another proxy via the network interface, the communication management module 205 sends the message to message analysis module 225 to determine whether the message is relevant to resource 245. Message analysis module 225 first retrieve the message composite code that is associated with the message and then divide (disintegrate) the message composite code to its independent elements, where each element represents data associated with an attribute of the message.

Message analysis module 225 then retrieves a resource composite code from the composite code database 220. If there is more than one resource composite code stored in the database 220 for resource 245, proxy 200 identifies a default resource composite code for use. Proxy 200 can also prompts resource 245 to identify one resource composite code for use in a particular context.

After a resource composite code is retrieved, message analysis module 225 is configured to compare the independent elements of the message composite code against the independent elements of the resource composite code to determine whether the information indicated by the resource composite code indicates that resource 245 fulfills the criteria set forth in the message composite code. For example, if the message composite code indicates that the message is for personnel from Department ‘A’, message analysis module 225 would check the resource composite code to determine whether resource 245 is one of the personnel from Department ‘A.’ If the message composite code indicates that the task request requires a resource with a certain knowledge, a certain education background, a certain experience, a certain reliability level, and/or a certain trustworthiness level, message analysis module 225 would check the corresponding element within the resource composite code to determine whether resource 245 has all that is required by the message composite code. In some embodiments, message analysis module 225 is configured to generate a resource-message compliance profile based on the comparison. It has been contemplated that more than one resource can determine a match with the message composite code (i.e., find that a message is relevant to them).

If message analysis module 225 determines that the message is not intended for resource 245 or that resource 245 does not fulfill the requirements set forth by the message composite code (based on the resource-message compliance profile), message analysis module 225 would discard the message. The analysis and discarding of the message is transparent to resource 245 such that resource 245 would not even be aware that a message from another resource has been received. On the other hand, if message analysis module 225 determines that the message is intended for resource 245 or that resource 245 does indeed fulfill the requirements set forth by the message composite code (based on the resource-message compliance profile), message analysis module 225 would present the message to resource 245 via the resource interface 210. This way, only relevant messages would be displayed before resource 245.

In some embodiments, in addition to properties of the resource 245, the resource composite code generated by composite code generating module 250 can either include instructions suitable for proxy 200 to execute or include executable software programs (that can be executed by one or more processors). Proxy 200 can prompt resource 245 via resource interface 210 for information to generate these instructions/programs.

The instructions/software program can include code, that when executed by the processors, perform actions based on the received message. For example, the instructions/software program can generate an automatic response to the message based on the message content. If the message includes a task request that involves a project that resource 245 is very much interested in, resource 245 can configure the proxy to automatically accept/bid on the task via the resource composite code. If the task/project requires more than one person to complete, and if resource 245 has preferred resources that resource 245 would like to partner with/use to complete the project, the instructions/programs can automatically send invite to the preferred resources.

In addition, the instructions/programs can automatically modify the message (e.g., flag the message as important, move the message to a folder, save to calendar, etc.) based on the content of the message. Further, the instructions/programs can automatically retrieve additional information associated with the message (e.g., information related to the task) based on the content of the message and then present the additional information to resource 245 via resource interface 210.

It is also contemplated that the resource composite code is portable, meaning the resource (e.g., resource 245) can take the resource composite code(s) anywhere (e.g., using a portable storage device such as a USB thumb drive, a portable hard drive, a flash memory card, a mobile device, etc.). It is envisioned that proxy can be implemented at all workstation everywhere (e.g., in all terminals, personal computers, etc.), and resource 245 can receive the same services disclosed herein at any workstations with a proxy installed. Resource 245 can provide his/her resource composite code(s) and the proxy will be able to perform the services described herein. Alternatively, the resource composite code(s) can be stored in the cloud, and resource 245 can instruct any proxy (e.g., proxy 200) to download the resource composite code(s) when resource 245 is authenticated with the proxy. Different manners of authentication (e.g., password, biometric, etc.) are known and will not be discussed in details herein.

Dynamic Workflow Generator

It has been contemplated that the message broadcasting system described above can be used in an automatic workflow generating system that enables resources to automatically determine a workflow for a task in an ad-hoc manner. A task (especially for a complicated task) involves multiple sub-tasks that are sometimes required to be perform in a particular order in order to complete the task. In some embodiments, the resources can use the message broadcasting system to automatically determine a workflow for a task in an ad-hoc manner.

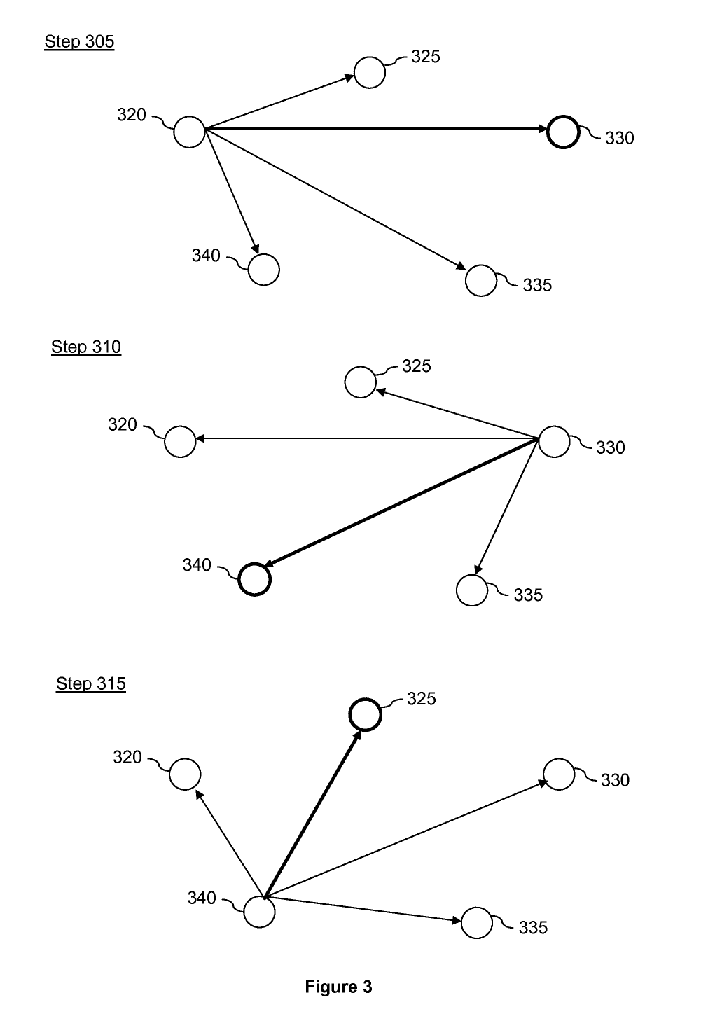

FIG. 3 illustrates an example of determining the workflow for a task among a set of resources under this approach through three steps—steps 305, 310, and 315. In this example, the set of resources (resources 320-340) would initiate a task and determine an ad-hoc workflow for the task among themselves. Each of the resources 320-340 also includes a proxy that is similar to proxy 200 of FIG. 2 that is configured to manage communication for its corresponding resource. Each of the resources 320-340 also has an associated resource composite code as the ones described above to specify the qualification, character, and interests of the resource.

In step 305, one of the resources (e.g., resource 320) would like to initiate a task. In some embodiments, the task is sufficiently complicated that it requires performance of multiple sub-tasks by one or more resources in order to complete the task. The proxy of resource 320 collects information about the task from resource 320 and any other resources and generates a task composite code for the task. The task composite code indicates a goal of the task and also other specifications (e.g., required quality, required skill level from performers of the task, time requirement, etc.). In some embodiments, the task composite code can also include a status code that indicates the stage of completion (i.e., what percentage of the task has been completed, which subtasks have been completed, etc.). At this stage, the status would indicate that nothing has been performed yet. In addition, the task composite code can also include information of what the next sub-task is in order to complete the task.

In some embodiments, the proxy of resource 320 follows a workflow template to determine what the next sub-task is supposed to be for the task. The workflow template includes examples of different tasks and for each example task, a template of the sub-tasks (indicating a particular performance order of the sub-tasks). It is contemplated that each template list of sub-tasks serves only a template that can be updated/modified by the resources (and/or their corresponding proxies) in view of the specific circumstances that arise during the performance of the subtasks.

a. External Factors in Determining Workflow

In some embodiments, the proxy will also look into external factors (by retrieving information via third parties), such as economic factors (e.g., change in costs of materials, change in demand of product being produced under the task, etc.), environmental factors (e.g., change in policies by the government, weather prediction, etc.), to determine how to update/modify the workflow. For example, if the proxy determines that the demand of the proposed product under the task will rise, the proxy might update the task composite code to indicate an increase of production quantities before broadcasting the task composite code to the other resources in the entity. Therefore, the proxy of resource 320 of some embodiments would also track and monitor economic and environmental information (e.g., weather information, supply and demand of materials and goods information, market information, supply information, etc.) that is relevant to performing the task. In some of these embodiments, the proxy is configured to modify/update the task composite code based on the economic and environmental information. From the economic and environmental information, the task composite code can be updated to add new sub-task(s), remove sub-task(s), and/or modify an existing sub-task on the template, thereby creating ad-hoc workflow that is generated based on up-to-date information of the project. The proxy of resource 320 then broadcasts a message that includes the task composite code to the remaining resources 325-340.

After the task has been broadcasted, the proxy of each of the remaining resources (resources 325-340) would perform the analysis as described above to determine whether the message/task is relevant to the corresponding resource (e.g., determining whether the corresponding resource is capable of performing the first sub-task of the task). In some embodiments, the proxies perform the analysis by comparing the task composite code against the resource composite codes of the corresponding proxies. In this example, only the proxy for resource 330 has determined that the message/task is relevant to resource 330 (i.e., the proxies for the other resources 325, 335, and 340 have determined that the message/task is not relevant for their corresponding resources). Presumably, resource 330 would complete the first sub-task after receiving the message.

b. Multiple Levels of Workflow

Alternatively, resource 330 can delegate part of (or the entire) sub-task to another set of resources (e.g., a third party vendor, a different department, etc.). In this event, the proxy of resource 330 can create a new task composite code that encompass the scope of the sub-task assigned to resource 330, and broadcast the task composite code to the set of resources. The set of resources can use the same scheme as described here to automatically determine the workflow to complete the sub-task among the set of resources by having different resources perform different sub-subtask, and will report back to resource 330 once the subtask is completed. Additionally, one or more resources within the set of resources can either perform the sub-subtask themselves or further delegate the sub-subtask to another set of resources using the same message broadcasting system. As such, the same broadcasting scheme can be carried on by several layers of different sets of resources for a project.

In some embodiments, after finishing the sub-task assigned to the resource 330 (as mentioned above, the sub-task can be completed by resource 330 or another set of resources), the proxy of the resource 330 will evaluate the quality of the work product being performed for the sub-task to determine the next step in the workflow. For example, if the proxy determines that the work product is below par (having problems/issues), the proxy can update the task composite code to indicate that someone else has to fix the problems/issues before initiating a subsequent sub-task and broadcasting the updated task composite code to the other resources in the entity.

As mentioned above, it has been contemplated that circumstances that affect the workflow of the task can arise when the task (or any of the subtasks related to the task) is being performed. For example, a sudden shortage of a part that is required for making a product for the task can give rise to purchasing/using a replacement part. In another example, for a task that involves producing a certain product, a market research indicating that the demand of the product (being the end product of the task) will increase dramatically might cause the task to require a higher volume in production of the product.

Thus, in addition, the proxy of resource 330 would also track or receive economic/environment information (e.g., weather information, economic condition information, market information, supply information, etc.) as well as information related to the quality of the work product for the sub-task. Based on a combination of the information about the sub-task and the economic/environment information, the proxy of resource 330 of some embodiments would determine what the next (second) task should be (or modify the second subtask within the template workflow). The proxy would also update the status code within the task composite code and insert information regarding the second sub-task into the task composite code. Thus, the workflow of the task and the resources are configured to adapt to the new environmental circumstance and also information of the quality of the work product.

After the task composite code is updated, the proxy of resource 330 would broadcast the updated message along with the updated task composite code and any other information related to the task to the other resources (resources 320, 325, 335, and 340).

Step 310 illustrates that the proxy of resource 330 has broadcasted the message to resources 320, 325, 335, and 340, as illustrated by the arrows. Similar to step 305, the proxies of resources 320, 325, 335, and 340 would perform the analysis to determine if this message is relevant to the corresponding resource. It is noted that the message being broadcasted at this stage 310 is different from the message being broadcasted in stage 305, as the message has includes new status (after resource 330 has performed the first sub-task) and updated information. In this example, only the proxy of resource 340 has determined that the message is relevant to resource 340 (i.e., resource 340 can perform the second sub-task). Again, the proxy of resource 340 tracks the progress and status of the subtask and updates the task composite code accordingly (so that the task composite code has information about the third sub-task). In addition, the proxy of resource 340 also tracks environmental information and updates the task composite code as well.

After the second sub-task is completed and the task composite code is updated, the proxy of resource 340 then broadcasts the message to resources 320-335, as illustrated in step 315. In this example, only the proxy of resource 325 determines that the message is relevant to resource 325 (i.e., resource 325 can perform the third sub-task). After completing the third sub-task, the proxy of resource 325 has determined that task has finally completed. The proxy of resource 325 can broadcast a message indicating the completion of the task to the resources (resources 320, 330, 335, and 340) at this point. Since resource 320 is the originator of the message, only the proxy of resource 320 would find this message indicating the completion of the task to be relevant to the corresponding resource 320.

How a Proxy Works

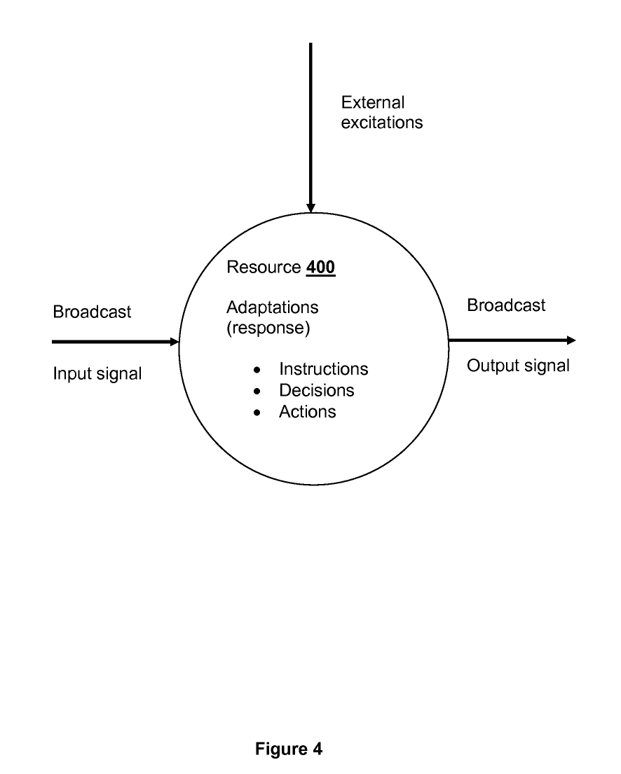

FIG. 4 illustrates the conceptual ideas of what each resource (and its proxy) does in the automated workflow generation system. Resource 400 can be any resources within an organization. Resource 400 is configured to receive a broadcasted input signal from another resource via its proxy. If the proxy is determined that the signal is relevant to resource 400, the proxy would relate the signal to the resource. Resource 400 then takes the instructions that are embedded within the signal (in the form of a task composite code) and perform a task (or sub-task). In some embodiments, the proxy also retrieves external excitations (i.e., environmental data). The external excitations can affect the way the resource 400 performs the task (or sub-task). Thus, resource 400 makes decisions and performs actions according to both the input signal and external excitations.

The external excitations can also affect how the proxy of resource 400 determine the next sub-task within the workflow. Based on the status of completion of the subtask (and quality and other characteristics), and also the external excitations, the proxy modifies/updates the task composite code to generate the output signal. The proxy of resource 400, upon completion of the subtask, would broadcast the output signal to the other resources. This way, each resource can adapt to the unique circumstance at the time the resource is performing the task (or sub-task) based on the received external excitations and determine an ad-hoc workflow for the overall task or project.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A resource management system, comprising:
a plurality of resources communicatively coupled with each other via a plurality of proxies;
wherein each resource in the plurality of resources is associated with a resource composite code representing a set of attributes of the resource,
wherein a first resource is configured to indiscriminately broadcast, to the plurality of resources, a task comprising a task composite code representing properties of the task,
wherein the proxy of a second resource is configured to:
upon receiving the task and its associated task composite code from the first resource, generate a resource-task compliance profile by comparing the task composite code against the resource composite code of the second resource, and
restrict presentation of the task to the second resource when the resource-task compliance profile satisfies a set of rules.

2. The resource management system of claim 1, wherein the second resource is a human.

3. The resource management system of claim 1, wherein the second resource is a machine.

4. The resource management system of claim 1, wherein the second resource comprises a computing device.

5. The resource management system of claim 1, wherein the proxy comprises a software executable by at least one processor.

6. The resource management system of claim 1, wherein the proxy of the second resource is further configured to provide an interface that allows the second resource to modify the resource composite code.

7. The resource management system of claim 1, wherein the proxy of the second resource is further configured to dis-integrate the task composite code into its dis-integrated elements.

8. The resource management system of claim 7, wherein the proxy of the second resource is further configured to determine the resource-task compliance profile by comparing each of the dis-integrated elements against the resource composite code.

9. The resource management system of claim 7, wherein each dis-integrated element represents a requirement of the task.

10. The resource management system of claim 1, wherein the resource composite code is associated with programming code executable by a processor.

11. The resource management system of claim 10, wherein the proxy of the second resource is further configured to execute the programming code of the resource composite code upon receiving the task.

12. The resource management system of claim of claim 10, wherein the programming code is configured to analyze the task composite code and perform an action based on the analysis.

13. The resource management system of claim 12, wherein the action comprises responding to the first resource.

14. The resource management system of claim 12, wherein the action comprises bidding for the task.

15. The resource management system of claim 12, wherein the action comprises retrieving additional information related to the task.

16. The resource management system of claim 15, wherein the action further comprises presenting the additional information to the second resource.

17. The resource management system of claim 1, wherein at least two proxies presents the task to their corresponding resources based on comparisons between the task composite codes and the corresponding resource composite codes.

18. A method of managing communications among resources of an organization comprising a plurality of resources communicatively coupled with each other via a plurality of proxies, the method comprising:
assigning to each resource in the plurality of resources a resource composite score representing a set of attributes of the resource;
indiscriminately broadcasting, by a first resource to the plurality of resources, a task comprising a task composite code that represents properties of the task;
upon receiving the task and its task composite code at a proxy of a second resource, generating a resource-task compliance profile by comparing the task composite code against the resource composite code of the second resource;
restricting, by the proxy, presentation of the task to the second resource when the resource-task compliance profile satisfies a set of rules.

19. The method of claim 18, further comprising dis-integrating, by the proxy, the task composite code into its dis-integrated elements.

20. The method of claim 18, further comprising determining, by the proxy, the resource-task compliance profile by comparing each of the dis-integrated elements against the resource composite code.

21. The method of claim 18, wherein each dis-integrated element represents a requirement of the task.
